(19) United States
(12) Patent Application Publication
(10) Pub. No.: US 2004/0249773 A1
(43) Pub. Date: Dec. 9, 2004

(54) DIAGNOSTIC MULTILEVEL POLYMORPHIC STATE MACHINE TECHNICAL FIELD

(75) Inventor: Joseph James Chianese, Brookfield, WI (US)

Correspondence Address: ARTZ & ARTZ, P.C., 28333 TELEGRAPH RD., SUITE 250, SOUTHFIELD, MI, 48034, US

(73) Assignee: GE MEDICAL SYSTEMS GLOBAL TECHNOLOGY COMPANY, LLC, Waukesha, WI (US)

(21) Appl. No.: 10/250,091

(22) Filed: Jun. 3, 2003

(51) Int. Cl. G06F 15/18

(52) U.S. Cl. 706/14

(57) ABSTRACT

A diagnostic polymorphic state machine (12) for a multiprocessor system (15) includes a coordinator state machine (86) controlling diagnostic operations. Multiple node state machines (88) are in communication with the coordinator state machine (86) and perform diagnostic testing on associated task devices. The coordinator state machine (86) and the node state machines (88) are used in a hierarchal manner to enable polymorphic diagnostic testing of the task devices.

### BACKGROUND OF INVENTION

The present invention relates generally to diagnostic testing within multiprocessor systems, and more particularly, to a system and method of performing diagnostic testing within a magnetic resonance (MR) imaging system.

In magnetic resonance imaging, a patient is typically positioned within a strong, temporally constant magnetic field. A series of spatial location encoding magnetic field gradient pulses are applied across a region of interest within the magnetic field. Radio frequency pulses are applied for inducing and manipulating magnetic resonance of dipoles in the region of interest. A radio frequency receiving coil is positioned over a portion of a patient to receive radio frequency magnetic resonance signals emanating from the region of interest for subsequent image reconstruction.

In order to perform various system tasks an MR imaging system includes a host computer coupled to one or more chasses. Each chassis may contain various distributed processors and task boards thereon. Multiple processors exist for performing image filtering, reconstruction, pulse sequencing, and system control. Communications between the host computer and other processors exist via an Ethernet or a back plane.

In order to maintain proper operation of and to repair the MR imaging system the host computer contains software for diagnostic testing of the system including the stated processors and the other task performing devices. The host computer processes diagnostic tests in the form of a diagnostic prescriptions, which are directed to respective and assigned processors. Each diagnostic prescription has associated tests to assure proper operation of a component of interest.

It is difficult to troubleshoot a MR imaging system with distributed processors when one or more of the processors are not responding or hung. When a processor is not responding, system dynamics change, which prevents initialization of diagnostic code needed for performing diagnostic testing. Without diagnostic initialization the system becomes much more difficult to troubleshoot. Current diagnostic techniques do not account for a nonresponding processor and are thus incapable of further continuing to perform diagnostics. In a hung situation the host processor, for example, may wait indefinitely for a response from one of the processors, when no response is possible. Even a single point of failure can result in the system becoming hung and prevents any further diagnostic testing by the host processor.

The status of a MR imaging system can change. It is not uncommon for several potential points of failure to exist and for these potential failure points to change over time; current diagnostic tools are incapable of being executed in this kind of environment.

It would therefore be desirable to provide a system with diagnostic testing capability that minimizes MR imaging system downtime and provides an efficient method of performing system diagnostics even when a system controller is not responding. It is also desirable that the system be easily adaptable to operate in conjunction with various applications and be flexible to run on various hardware configurations.

### SUMMARY OF INVENTION

The present invention provides a system and method of performing diagnostic testing within a MR imaging system. A diagnostic polymorphic state machine is provided for a multiprocessor system that includes a coordinator state machine controlling diagnostic operations. Multiple node state machines are in communication with the coordinator state machine and perform diagnostic testing on associated task devices. The coordinator state machine and the node state machines are used in a hierarchal manner to enable polymorphic diagnostic testing of the task devices.

One of several advantages of the present invention is that it provides a diagnostic polymorphic state machine that has a hierarchal diagnostic testing platform, which is capable of adapting to various existing system configurations. In so doing, the present invention does not become locked or hung do to a single or even multiple points of failure.

Another advantage of the present invention is that it is versatile in that it provides multiple devices that may be modified and updated allowing the system to be easily adapted to operate in various applications and on various hardware configurations.

Furthermore, the present invention provides multiple interfaces to execute diagnostics further preventing the diagnostic state machine from being in a situation where it is unable to respond.

Moreover, diagnostics of the present invention operate in conjunction with a given application to provide an efficient method of determining points of failure.

The present invention itself, together with attendant advantages, will be best understood by reference to the following detailed description, taken in conjunction with the accompanying figures.

### BRIEF DESCRIPTION OF DRAWINGS

For a more complete understanding of this invention reference should now be had to the embodiments illustrated in greater detail in the accompanying figures and described below by way of examples of the invention wherein:

FIG. 1 is a perspective view of a magnetic resonance imaging system utilizing a diagnostic multilevel polymorphic state machine in accordance with an embodiment of the present invention;

FIG. 2 is a block diagrammatic view of the magnetic imaging system of FIG. 1 in accordance with an embodiment of the present invention;

FIG. 3 is a block diagrammatic view of a diagnostic multilevel polymorphic state machine platform in accordance with an embodiment of the present invention;

FIG. 4 is a coordinator state diagram in accordance with an embodiment of the present invention;

FIG. 5 is a node state diagram in accordance with an embodiment of the present invention; and

FIG. 6 is a logic flow diagram illustrating a method of performing diagnostic testing within the magnetic resonance imaging system in accordance with an embodiment of the present invention.

### DETAILED DESCRIPTION

In the following figures the same reference numerals will be used to refer to the same components. While the present invention is described, for simplicity, with respect to a system and method of performing diagnostic testing within a MR imaging system, the following system and method is capable of being adapted for various purposes and is not limited to the following applications: systems having multiple processors, magnetic resonance imaging (MRI) systems, CT systems, radiotherapy systems, X-ray imaging systems, ultrasound systems, nuclear imaging systems, magnetic resonance spectroscopy systems, and other applications requiring diagnostic testing.

In the following description, various operating parameters and components are described for one constructed embodiment. These specific parameters and components are included as examples and are not meant to be limiting.

Also, in the following description the term “task device” may refer to any task-performing device within an operating system. A task device may be a processor, such as a host processor or a secondary processor, a dumb board, an electronic or mechanical task performing device or component, or other task performing device known in the art. For example, in an MR imaging system a task device may refer to a host processor, any card, board, bridge, backplane, or processor within an MR resonance imaging chassis, and any external electronic or mechanical operating device that is coupled to or controlled by the chassis.

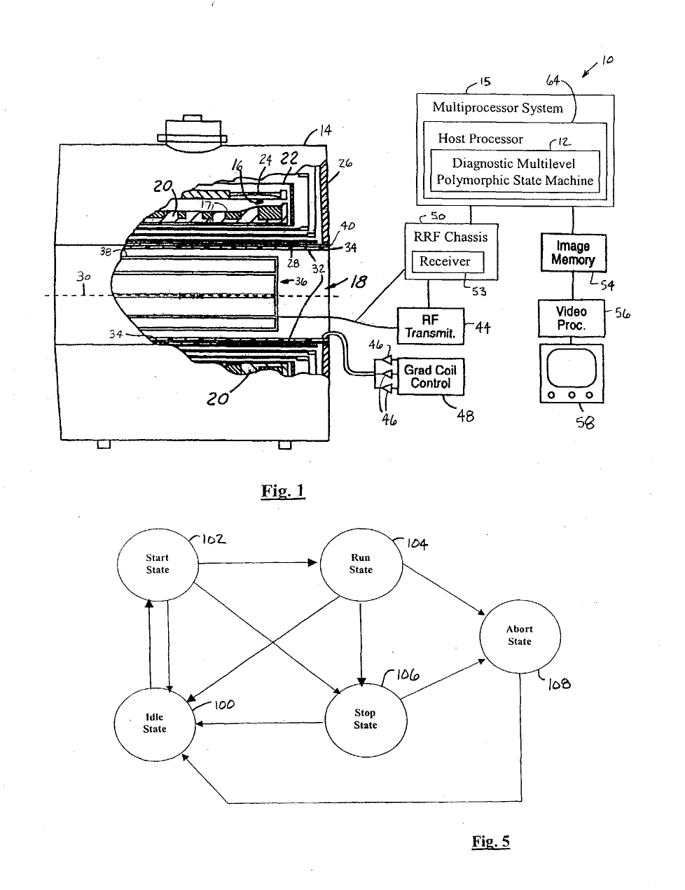

Referring now to FIG. 1, a perspective view of a magnetic resonance imaging system 10 utilizing a diagnostic multilevel polymorphic state machine 12 in accordance with an embodiment of the present invention is shown. The MRI system 10 includes a static magnet structure 14 (a cylindrical structure) and a multiprocessor system 15 having the polymorphic state machine 12. The MRI system 10 is shown as to provide one example of a multiprocessor system; the present invention may be applied to various other multiprocessor systems. The multiprocessor system 15 reconstructs an image for a region of interest of a patient in response to radio frequency magnetic resonance signals, as further described below.

The static magnet structure 14 includes a superconducting magnet 16 having a plurality of superconducting magnetic field coils 17 which generate a temporally constant magnetic field along a longitudinal axis (z-axis) of a central bore 18 (patient bore). The superconducting magnet coils 17 are supported by a superconducting magnet coil support structure 20 and received in a toroidal helium vessel or can 22.

A main magnetic field shield coil assembly 24 generates a magnetic field that opposes the field generated by the superconducting magnet coils 17. A toroidal vacuum vessel 26 includes a cylindrical member 28 that defines the patient bore 18 and extends parallel to a longitudinal axis 30. On a first exterior side 32 of the cylindrical member 28, which is longitudinal side farthest away from the axis 30, is a magnetic gradient coil assembly 34.

The patient bore 18 has a RF coil assembly 36 (antennae) mounted therein. The RF coil assembly 36 includes a primary RF coil 38 and a RF shield 40.

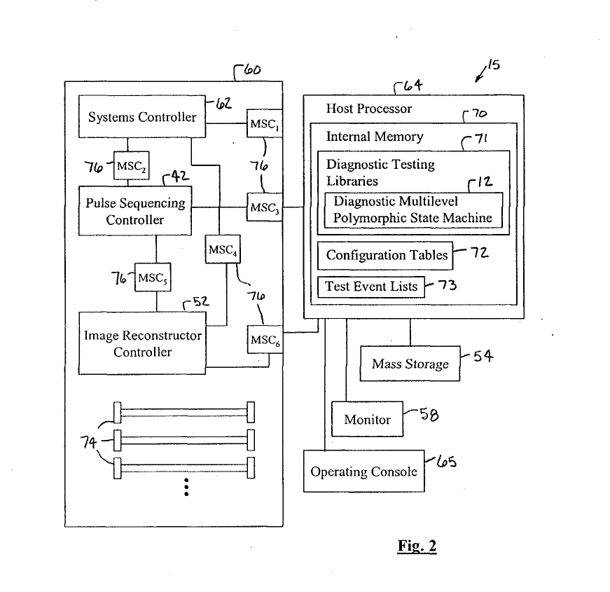

The multiprocessor system 15 includes a pulse sequence controller 42, as best seen in FIG. 2 that is coupled to a RF transmitter 44, which is further coupled to the primary RF coil 38. The RF transmitter 44 is preferably digital. The sequence controller 42 controls a series of current pulse generators 46 via a gradient coil controller 48 that is coupled to the magnetic gradient coil assembly 34. The RF transmitter 44 in conjunction with the sequence controller 42 generates a series of spatially located radio frequency signals or encoded magnetic field gradient pulses that are applied across a region of interest within the magnetic field for exciting and manipulating magnetic resonance in selected dipoles of the region of interest, such as a portion of a patient within the patient bore 18.

A remote radio frequency (RRF) chassis 50 is coupled between an image reconstructor controller 52 of the multiprocessor system 15, also as best seen in FIG. 2, and the primary RF coil 38 and demodulates receives magnetic resonance signals emanating from an examined portion of the subject, via a receiver 53. The image reconstructor controller 52 reconstructs the received magnetic resonance signals into an electronic image representation that is stored in an image memory 54. A video processor 56 converts stored electronic images into an appropriate format for display on a video monitor 58.

Although the gradient coil controller 48, the transmitter 44, the RRF chassis 50, the image memory 54, and the video processor 56 are shown as being separate from the multiprocessor system 15 they may be included and be an integral part of the system 15.

Referring now to FIG. 2, a block diagrammatic view of the multiprocessor system 15 in accordance with an embodiment of the present invention is shown. The diagnostic processing system includes a control mechanism or control chassis 60. Chassis 60 includes the pulse sequencing controller 42, the image reconstructor controller 52, and a systems controller 62. The pulse sequencing controller 42 controls sequencing of electromagnetic pulses and manner as to which analog signals are converted to digital signals for subsequent processing. The image reconstructor controller 52 receives sampled and digitized data from the receiver 53 and performs high-speed image reconstruction. The systems controller 62 provides scanning, power, and timing signals to components and devices within the magnet structure 14 as well as to the gradient coil controller 48, the transmitter 44, and the RRF chassis 50. A host processor 64 stores the reconstructed image in image memory 54, which may be in the form of a mass storage device.

The host processor 64 also receives commands and scanning parameters from an operator via an operator console 65. The display or monitor 58 allows the operator to observe the reconstructed image and other data. Operator supplied commands and parameters are used by the host processor 64 in operation of the pulse sequencing controller 42, the image reconstructor controller 52, and the systems controller 62.

The pulse sequencing controller 42, image reconstructor controller 52, systems controller 62, and the host processor 64 are preferably based on micro processors, such as a computer having a central processing unit, memory (RAM and/or ROM), and associated input and output buses. The pulse sequencing controller 42, image reconstructor controller 52, systems controller 62, and the host processor 64 may be a portion of a central control unit or may each be stand-alone components as shown. In the embodiment of FIG. 2, the host processor 64 may be considered a primary processor whereas the pulse sequencing controller 42, image reconstructor controller 52, systems controller 62 may be considered as secondary processors.

The sequencing controller 42 controls pulsing of various devices and as stated above the manner as to which digital signals are converted into analog signals. The reconstructor controller 52 filters the projection data and reconstructs an image for a region of interest (not shown) of the patient. The systems controller 62 controls scanning of a patient, such as providing an appropriate sequencing start time and scanning rate, as well as other scanning parameters known in the art.

The host processor 64 includes an internal memory 70 for storage of diagnostic testing libraries 71, configuration tables 72, and test event lists 73, which may be continuously modified and updated. The diagnostic testing library 71 includes the polymorphic state machine 12 that has various test prescriptions for various hardware and software devices and configurations, allowing quick development of new diagnostic techniques for new configurations. Each test prescription may have multiple diagnostic tests and associated events that are to be performed within each test. Configuration tables 72 are referred to by the host processor 64 to determine a proper test prescription for a given system configuration. The test event lists 73 are described below.

In addition to the controllers and processors shown the chassis 60 may also include other various processors and boards, which are represented by bars 74, for performing tasks such as sequencing, filtering, image reconstruction, control of other chassis, calculations, and other tasks known in the art. The diagnostic processing system may be modified to perform diagnostic testing on the other processors and boards 74, as will become more evident in light of the following description. The processors and boards 74 may be coupled to various devices within the system 10.

The multiprocessor system 15 includes the host processor 64 and the secondary processors 42, 52, and 62. Although, a specific number of processors are shown for both the imaging system 10 and the multiprocessor system 15 any number of processors may be incorporated. The secondary processors 42, 52, and 62 are coupled to each other and to the host processor 64 via multicast socket connections 76, enabling parallel packet communication therebetween and allowing multiple processors to receive an identical packet simultaneously.

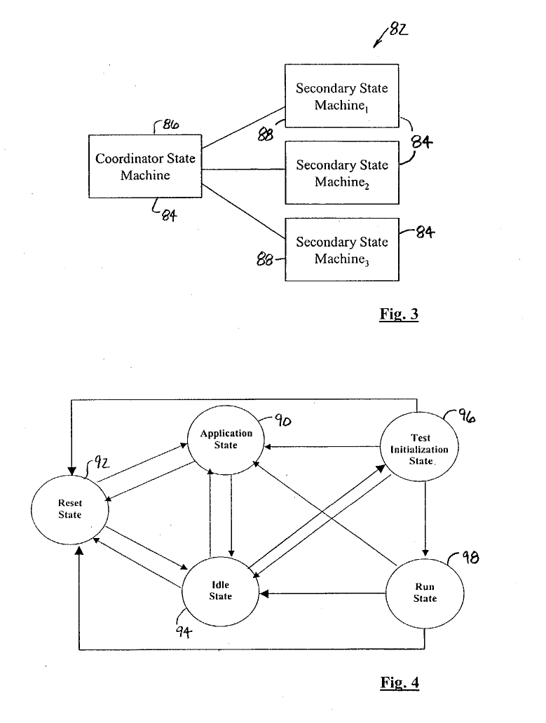

Referring now also to FIG. 3, a block diagrammatic view of a multilevel polymorphic state machine diagnostic platform 82 in accordance with an embodiment of the present invention is shown. The platform 82 includes multiple level state machines 84 that are associated with the host processor 64 and each of the secondary processors 42, 52, and 62, including a primary or coordinator state machine 86 and multiple node state machines 88; a node state machine 88 exists per secondary processor 42, 52, and 62. The state machines 84 are software based. The host processor 64 stores each of the level state machines 84 in the internal memory 70. The host processor 64 uses the level state machines 84 in a hierarchal manner to enable polymorphic diagnostic testing of various task devices.

The processors 64, 42, 52, and 62 are capable of performing diagnostic tasks in parallel, for example, a secondary processor may perform a test on a first set of devices and, during the same time period, another secondary processor may perform a test on a second set of devices, thus providing diagnostic efficiency. The processors 64, 42, 52, and 62 operate the level state machines 84 in parallel in response to a test prescription and a component query, which are described in further detail below. Each of the secondary processors 42, 52, and 62 have a corresponding state machine 88 that performs diagnostic testing of associated task devices within the imaging system 10.

Although, the diagnostic platform 82 is shown having four state machines, the platform may have zero or any number of state machines, substate machines, and corresponding nodes. Each state machine that is included in the polymorphic state machine 12 is tracked by the host processor 64.

Referring now to FIG. 4, a coordinator state diagram in accordance with an embodiment of the present invention is shown. The coordinator state machine 86 is controlled by system events and tracks the overall state of the multiprocessor system 15 including scanning, calibration, resets, and the like. The coordinator state machine 86 has control over diagnostic operations and communicates to the secondary or node state machines 88 events and actions to be performed.

The coordinator state, machine 86 has five main operating states: an application state 90, a reset state 92, an idle state 94, a diagnostic initialization test state 96, and a run state 98, as shown. Although, the present invention primarily concerns the test initialization state 96, the other states are described in brief detail below.

The application state 90 is executed on receipt of a scan start signal from the host processor 64. The coordinator state machine 86 remains in the application state until receiving an end of an exam signal or a reset signal.

The reset state 92 is executed when a reset started signal is received. The coordinator state machine 86 remains in this state until a reset complete signal or a timeout signal is generated. The present invention uses multiple timeout signals. A timeout signal may be generated for any task device. A timeout signal is generally generated when a task device is not responding appropriately or simply not responding for a predetermined length of time.

The idle state 94 is the initial state of the coordinator state machine 86, which is when no event is being performed. Idle state 94 indicates that no diagnostic activity is occurring and all node state machines 88 are inactive.

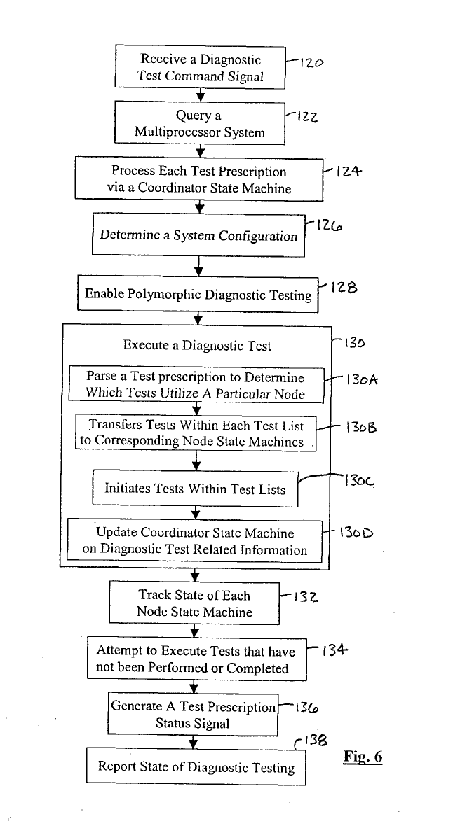

The test initialization state 96 is the first state that the coordinator state machine 86 executes upon receiving a valid diagnostic prescription. In this state the coordinator state machine 86 performs multiple tasks, which are described in detail in the method of FIG. 6 in steps 102-112.

When in the run state 98 the coordinator state machine 86 or at least one of the node state machines 88 is actively performing a diagnostic test. The coordinator state machine 86 remains in this state until at least all node state machines 88 exit their active diagnostic states.

Referring now to FIG. 5, a node state diagram in accordance with an embodiment of the present invention is shown. The node state machines 88 also have five main operating states: an idle state 100, a start state 102, a run state 104, a stop state 106, and an abort state 108. Although, the present invention primarily concerns the start state 102 and the run state 104, the other states are described in brief detail below.

The idle state 100 is an initial state of the node state machines 88 when no test event is being performed. The coordinator state machine 86 may return to the idle state 94 when all of the node state machines 88 are in the idle state 100.

The node state machines 88 are in the start state 102 when a test prescription is received and a response is expected from the coordinator state machine 86. A timeout signal is generated for this state after approximately a couple of seconds to insure that a node state machine 88 is not hung. Failure to transmit the expected response causes the coordinator state machine 86 or the node state machine 88 to generate an abort signal causing the node state machine 88 to execute the abort state 108.

The run state 104 is executed when a node state machine 88 is actively performing a diagnostic test. A timeout limit to perform a diagnostic test may also exist and may be executed during this state. Timeout period is stored with a respective test in a test configuration file. When a timeout has occurred for this state the associated node state machine 88 exits the run state 104 and enters the stop state 106. A stop message is transmitted to the host processor 64 in the event of a timeout.

The stop state 106 is executed when a stop command is received from a user or a timeout has occurred during the run state 104. The stop state 106 also times out when a predetermined amount of time has passed and a test completion signal is not generated by the node state machine 88. Failure to complete a test in a given time period causes an associated node state machine 88 to generate an abort signal.

The abort state 108 is executed when a test times out, for example when a task device is hung or operating in an infinite loop, which is sometimes referred to as a run-away test. The coordinator state machine 86 waits for a couple additional seconds beyond that of the predetermined time period, to assure that a task device is operating inappropriately, before generating an abort signal, which is received by the hung node state machine 88. Upon receiving the abort signal, the node state machine 88 discards any diagnostic information gathered during the previous test. The coordinator state machine 86 may signal the node state machine 88 to restart the test, perform a different test, or abort any tests requiring use of that node.

Although, the coordinator state machine 86 and the nodes state machines 88 are shown each having five main states, which are illustrated in FIGS. 4 and 5, each of them may have zero or any number of states or substates. The state machines 86 and 88 may also have other states or substates known in the art.

Referring now to FIG. 6, a logic flow diagram illustrating a method of performing diagnostic testing within the imaging system 10 in accordance with an embodiment of the present invention is shown.

In step 120, the host processor 64 receives a diagnostic test command signal to initiate a test prescription. The coordinator state machine 86 is initiated to perform diagnostic testing.

In step 122, the host processor 64 queries the multiprocessor system 15 for determining which nodes are present. Diagnostic testing is enabled when the host processor 64 and the chassis 60 are in a proper state. When an MR scan is being performed, for example, diagnostic testing is disabled. The coordinator state machine 86 executes the test initialization state 96, which includes the above-stated query, upon receiving a valid diagnostic prescription that may be selected via the console 65 or by the host processor 64.

In step 124, the coordinator state machine 86 processes each test prescription before the tests are transmitted to the node state machines 88. The coordinator state machine 86 determines when and to which secondary processor to transfer a node state machine 88.

In step 126, the host processor 64 determines a system configuration in response to the node presence to generate a current system configuration signal. Active nodes respond to the query with information required to connect to that node and a corresponding diagnostic identification code. The current system configuration signal may include information, such as which nodes are active, responding, performing appropriately, hung, have points of failure, as well as other system configuration information known in the art.

In step 128, the host processor 64 enables polymorphic diagnostic testing by enabling appropriate node state machines 88 from the coordinator state machine 86 in response to the current system configuration signal. In one embodiment of the present invention the nodes that respond from the query of step 102 and have only isolated points of failure are enabled. The coordinator state machine 86 determines which nodes or processors, including the host processor 64, are available for which diagnostic tests and transmits an associate state machine to those processors that are available. A diagnostic test may include more than one node or task device.

In step 130, secondary processors 42, 52, and 62 receive a diagnostic prescription from the node state machines 88. The node state machines 88 execute one or more diagnostic tests when a node-associated criteria is met. The criteria may include a level as to how far a node“came up” or booted, whether a node is capable of operating a given application or diagnostic test in a current condition, or other known criteria. Tests are executed in parallel with available resources to provide diagnostic efficiency.

In step 130A, each node state machine 88 parses a test prescription to determine which tests utilize that particular node through use of the configuration tables 72 having corresponding configuration files for each node. The configuration tables 72 provide ease in adding state machines to an existing configuration. The test lists 73 may be generated for each node state machine 88 containing each test and events within each test that are to be performed on a particular node state machine.

In step 130B, the coordinator state machine 86 transfers tests within each test list 73 to the corresponding node state machines 88 for diagnostic processing. In step 130C, the node state machines 88 initiate tests within the test lists 73.

In step 130D, the node state machines 88 update the coordinator state machine 86 in regards to diagnostic test related information, such as current status of a test for a particular node state machine.

When a processor is not available for processing a given test the coordinator state machine 86 either does not perform that test or waits until other processors complete that test before attempting to enable a different or subsequent test on the unavailable processor. Certain tests may be performed on a single processor where as other tests may utilize multiple processors.

Tests may be divided into three categorical groups: board level tests, data path tests, and functional tests. The separate categories aid in preventing conflicts in test execution between processors and insure efficiency of execution. The coordinator state machine 86 sequences through these categories until requested iterations are completed.

The board level tests do not require enablement of application code and are thus executed together. The data path tests use application code and are also executed together. In so doing, the present invention provides efficiency in preventing continual enabling and disabling of application code during execution. The functional tests are single diagnostic tests that are executed one at a time and not simultaneously with other diagnostic tests.

In step 132, each node state machine 88 may track state of that node. The node state machines 88 may track parameters such as resource usage, parallel testing status, system environmental changes, secondary processor responses and timeouts, test prescription distribution, and other tracking parameters known in the art. Whenever an error message is generated by a node state machine 88, during a diagnostic test, diagnostic test information related to that error message may be attached to the error message for subsequent review.

In step 134, when the node state machines 88 have completed performing the assigned tests, the coordinator state machine 86 has the node state machine parse their corresponding test lists to execute tests that have not been performed or completed.

In step 136, the coordinator state machine 86 parses a test prescription to determine which tests and events have occurred and have been completed and generates a test prescription status signal. Diagnostic results are returned to the coordinator state machine 86 and then the node state machines 88. Results thereof are stored in the internal memory 70. The internal memory 70 may have various diagnostic history files, which may be updated during diagnostic testing as well as at completion of diagnostic testing.

In step 138, the host processor 64 reports state of the diagnostic testing by indicating the prescription status signal on the monitor 58.

A timeout signal may be generated in any of the above stated steps. A timeout signal may be generated when time to determine the system configuration is greater than a predetermined length of time, when a state machine 84 is not responding appropriately, when the imaging system 10 is in an inappropriate state, or in other situations known in the art. When a timeout signal is generated, the host processor 64 may report known points of failure on the monitor 58. When abort conditions occur due to a timeout or due to some other event a test may be removed from a test list.

The above-described steps are meant to be an illustrative example; the steps may be performed synchronously, sequentially, simultaneously, or in a different order depending upon the application. Note that the present invention is capable of performing diagnostic testing on task devices that are capable of responding and does not wait indefinitely for a device that is not responding or hung.

The present invention provides a diagnostic testing polymorphic state machine that provides flexibility in design in that it is capable of adapting to various systems having any number of processors. The present invention is easily manipulated and allows for additional nodes to be added by creating new configuration files and state machines for additional processors. Additionally, the present invention provides diagnostic efficiency by minimizing potential for the diagnostic state machine to become hung and by being capable of performing multiple diagnostic tests simultaneously.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

1. A diagnostic polymorphic state machine for a multiprocessor system comprising:
a coordinator state machine controlling diagnostic operations; and
a plurality of node state machines in communication with said coordinator state machine and performing diagnostic testing on associated task devices;
said coordinator state machine and said plurality of node state machines configured to perform in a hierarchal manner and enabling polymorphic diagnostic testing of said task devices.

2. A multiprocessor system having a plurality of processors and a plurality of task devices with a plurality of associated tasks comprising:
a plurality of secondary processors electrically coupled to and associated with said plurality of task devices;
a host processor electrically coupled to said plurality of secondary processors and having a diagnostic multilevel polymorphic state machine for performing diagnostic testing of the multiprocessor system, said diagnostic multilevel polymorphic state machine comprising;
a diagnostic platform with a plurality of level state machines associated with each of said plurality of secondary processors and respective states thereof;
said diagnostic multilevel polymorphic state machine using said plurality of level state machines in a hierarchal manner to enable polymorphic diagnostic testing of the plurality of task devices.

3. A system as in claim 2 wherein said plurality of level state machines comprises:
at least one node state machine associated with each of said plurality of secondary processors; and
a primary state machine associated with said host processor and controlling overall operation of said diagnostic platform.

4. A system as in claim 3 wherein said primary state machine disables performance of at least one event within a test prescription when the multiprocessor system is in an inappropriate state.

5. A system as in claim 3 wherein said at least one node state machine tracks an operating state of a corresponding node thereof.

6. A system as in claim 3 wherein said at least one node state machine tracks at least one parameter selected from resource usage, parallel testing status, system environmental changes, secondary processor responses and timeouts, and test prescription distribution.

7. A system as in claim 3 wherein said at least one node state machine initiates events of a test prescription and updates said primary state machine.

8. A system as in claim 3 wherein said plurality of secondary processors, in response to a corresponding node state machine, parses a test prescription to determine which tests utilize said plurality of secondary processors and generates a processor test list.

9. A system as in claim 8 wherein said host processor transfers tests within said test list to said plurality of secondary processors for diagnostic processing.

10. A system as in claim 3 wherein said primary state machine enables said at least one node state machine in response to a current system configuration.

11. A system as in claim 3 wherein each of said at least one node state machine determines which events to perform for a given test prescription using a configuration table.

12. A system as in claim 2 further comprising at least one multicast socket connection coupled between said plurality of secondary processors and said host processor and enabling packet communication therebetween.

13. A system as in claim 2 wherein each of said secondary processors has a corresponding state machine that performs diagnostic testing of associated task devices of said plurality of task devices.

14. A system as in claim 2 wherein said plurality of secondary processors and said host processor operate said plurality of level state machines in parallel.

15. A system as in claim 2 wherein said plurality of secondary processors and said host processor operate said plurality of level state machines in parallel in response to a test prescription and a component query.

16. A method of performing diagnostic testing within a multiprocessor system having multiple processors comprising:
querying the multiprocessor system to determine node presence;
determining system configuration in response to said node presence;
enabling polymorphic diagnostic testing by enabling node state machines from a primary state machine in response to said system configuration; and
executing at least one diagnostic test in response to said system configuration.

17. A method as in claim 16 further comprising generating a time out signal when time to determine said system configuration is greater than a predetermined length of time.

18. A method as in claim 16 further comprising generating a time out signal when at least one node is not responding appropriately.

19. A method as in claim 16 wherein executing at least one diagnostic test comprises parsing a test prescription to determine which of said at least one diagnostic test utilizes a particular node.

20. A method as in claim 16 further comprising parsing a test prescription to determine which tests and events have occurred and have been completed.
